(19) United States
(12) Patent Application Publication
(10) Pub. No.: US 2005/0098994 A1
(43) Pub. Date: May 12, 2005

(54) Airbag cushion with angled recess

(75) Inventor: Shinzo Matsumura, Echi-gun (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 10/981,558

(22) Filed: Nov. 5, 2004

Related U.S. Application Data
(60) Provisional application No. 60/517,921, filed on Nov. 7, 2003.

(51) Int. Cl. B60R 21/16

(52) U.S. Cl. 280/743.1

(57) ABSTRACT

An airbag device with an improved airbag configuration to protect a vehicle occupant more efficiently. The airbag device is stored in the upper portion of an instrument panel of a vehicle under normal situations. The airbag device has an airbag that is deployable into a space in front of a vehicle occupant in the event of a vehicle emergency, such as a collision. The airbag viewed from the top when fully deployed and inflated has a right side portion, a left side portion, and a recess between the right and left side portions. When pressure is applied to the right and left side portions, the recess maintains a recessed shape.

### BACKGROUND OF THE INVENTION

This application claims the benefit of Provisional Application No. 60/517,921, filed Nov. 7, 2003

The present invention relates to an airbag device in which an airbag is inflated to protect a vehicle occupant in the event of a vehicle collision. More particularly, the present invention relates to an airbag device with an improved airbag configuration for protecting an occupant more efficiently.

An airbag for protecting a vehicle occupant is normally stored in a folded state in a cavity disposed in the middle section of a steering wheel or within an instrument panel of a vehicle. In the event of a vehicle collision, the airbag is deployed and inflated in the vehicle interior by gas produced by an inflator. The inflated airbag receives and restrains the occupant.

In conventional airbag devices, the airbag when deployed does not leave a sufficiently safe distance between the airbag contact surface and the vehicle occupant. Thus, in a vehicle emergency the kinetic energy of the occupant is not efficiently absorbed by the airbag, which may result in injury to the occupant. In addition, when the occupant has a small build, the seat is often pulled forward to the front-most position. Such an occupant is plunged into a conventional airbag before the seatbelt has sufficient time to absorb impact energy. As a result, some passengers, especially children, have been fatally injured.

Another disadvantage of conventional airbags is that the restraint force of the airbag is not focused on the mass point of the occupant's head. Thus, the kinetic energy of the occupant's head is not efficiently absorbed.

Because the energy absorption effect of conventional airbags is not optimized, such airbags require increased volume and an inflator with increased output.

### SUMMARY OF THE INVENTION

According to an embodiment of the present invention, an airbag device is provided. The airbag device includes an airbag that is normally stored in an upper part of an instrument panel. The airbag can be inflated and deployed into a space in front of a vehicle occupant in the event of an emergency, such as a vehicle collision. In a top view, the airbag upon completion of deployment has a right side portion, a left side portion, and a recess formed between the right and left side portions. The recess maintains a recessed shape when pressure is applied to the right and left side portions.

In a vehicle emergency, the shoulders of an occupant make contact with the right and left side portions of the airbag before the head of the occupant contacts the recess. The pressure in the right and left side portions increases and is supplied to the recess so as to increase the inner pressure of the recess. Thus, the energy absorption effect of the right and left side portions and of the recess is increased. As a result, the moving distance of the occupant before the occupant stops is reduced. Therefore, the need for increasing the output of the inflator is eliminated and initial restraint of the occupant is safely achieved.

Further, the increased energy absorption effect allows a reduction in the volume of the airbag. In addition, the recess provides an extra distance for the occupant's head to move and allows the occupant to be sufficiently decelerated by a seat belt before the occupant's head makes contact with the airbag.

According to another embodiment of the present invention, an airbag device is provided. The airbag device includes an airbag that is normally stored in an upper part of an instrument panel. The airbag can be inflated and deployed into a space in front of a vehicle occupant in the event of an emergency, such as a vehicle collision. When the airbag makes contact with the occupant's head during an emergency, the contact surface extends from the deepest section of the recess to the right side end of the recess (right contact surface) and from the deepest section of the recess to the left side end of the recess (left contact surface). The left and right contact surfaces are disposed at an angle of about 15 to 90 degrees (preferably 30 to 60 degrees) relative to the line extending through the deepest section of the recess in the longitudinal direction of the vehicle (the airbag centerline).

Thus, by projecting the front surface of the airbag toward an occupant, the area of the occupant's head corresponding to the mass point (center of gravity) of the occupant's head comes in contact with the front surface of the airbag, which enables more efficient restraint of the occupant's head during the initial stage of impact. If the angle between the contact surface and the airbag centerline exceeds about 90 degrees, the efficiency is lost. If the angle is less than about 15 degrees, the recess doesn't cover the occupant's head.

According to another embodiment of the present invention, an airbag device is provided. The airbag device includes an airbag that is normally stored in an upper part of an instrument panel. The airbag can be inflated and deployed into a space in front of a vehicle occupant in the event of an emergency, such as a vehicle collision. In a top view, the airbag upon completion of deployment has a right side portion, a left side portion, and a recess formed between the right and left side portions. The front surface of the airbag projects toward an occupant. The front surface is formed to project so that the area corresponding to the mass point (center of gravity) of the heads of occupants of different size builds comes in contact with the area of the front surface of the airbag extending from the deepest section of the recess to the right and left side ends of the recess.

Thus, because the front surface of the airbag projects toward an occupant, the mass point of the occupant's head can be restrained in an earlier stage of the impact. And since the energy absorption effect of the airbag is raised, the occupant's head can be restrained more efficiently during the earlier stage of the impact.

It is to be understood that both the foregoing general description and the following detailed description are exemplary and explanatory only and are not restrictive of the invention claimed.

### BRIEF DESCRIPTION OF THE DRAWINGS

These and other features, aspects, and advantages of the present invention will become apparent from the following description, appended claims, and the accompanying exemplary embodiments shown in the drawings, which are described briefly below.

FIG. 1(a) is a schematic top view of a front-passenger airbag device in the fully deployed state according to an embodiment of the present invention.

FIG. 1(b) is a schematic side view of the airbag device of FIG. 1(a).

FIG. 2(a) is a schematic top view of a front-passenger airbag device according to an embodiment of the present invention showing a state in which the occupant is moving forward.

FIG. 2(b) is a schematic top view of the airbag device of FIG. 2(a) showing the moment when the occupant's face comes in contact with the airbag.

FIG. 2(c) is a schematic top plan view the airbag device of FIG. 2(a) showing a state in which the occupant is being restrained by the airbag.

FIG. 3(a) is a rear view showing an airbag device according to an embodiment of the present invention.

FIG. 3(b) is a schematic side view of a left half of the airbag device of FIG. 3(a).

FIG. 4 is a perspective view of an airbag device according to an embodiment of the present invention.

FIG. 5 is a perspective view of an airbag device according to an embodiment of the present invention.

FIG. 6 is a perspective view of an airbag device according to an embodiment of the present invention.

FIG. 7 is a perspective view of an airbag device according to an embodiment of the present invention.

FIG. 8 is a schematic top view of an airbag device according to an embodiment of the present invention.

FIG. 9(a) is a perspective view of an airbag device according to an embodiment of the present invention.

FIG. 9(b) is a top sectional view of the airbag device of FIG. 9(a).

FIG. 10 is a schematic top view of an airbag device according to an embodiment of the present invention.

### DETAILED DESCRIPTION

Embodiments according to the present invention will be described with reference to the attached drawings. In the description below, the longitudinal direction is identical to that of a vehicle in which the head-protecting airbag is mounted. Although the following embodiments are directed to an airbag device for a passenger seat mounted in the upper part of a vehicle dashboard, the airbag device according to the present invention may be applied to an airbag other than for a passenger seat.

According to an embodiment of the present invention, an airbag device is provided. The airbag device includes an airbag that is normally stored in an upper part of an instrument panel. The airbag can be inflated and deployed into a space in front of a vehicle occupant in the event of an emergency, such as a vehicle collision. In a top view, the airbag upon completion of deployment has a right side portion, a left side portion, and a recess formed between the right and left side portions. The recess maintains a recessed shape when pressure is applied to the right and left side portions.

In a vehicle emergency, the shoulder portions of the occupant first press the airbag and are the first part of the occupant to receive a reaction force of the airbag. When the shoulders of the occupant press the airbag, the inner pressure of the airbag increases. Even when the inner pressure increases, the airbag is constructed such that the recessed shape of the airbag is maintained. Since the recessed configuration of the airbag is maintained, gas pressure is hard to leak out, which enhances the efficiency of restraining the occupant's shoulders at the initial stage of restraint. Thus, in such an airbag, the airbag is first compressed by the occupant's shoulders, which causes the inner pressure (reaction force) of the airbag to rise. The increased inner pressure enhances the initial restraint of the occupant's shoulders. Next, since the airbag has a recess and the area where the recess is formed does not deform much, gas is supplied into the airbag without a substantial deformation of the recess and without lowering the inner pressure. As a result, the inner pressure of the airbag, including the recess, is raised higher than that of a conventional airbag. Occupant restraint capability is thus improved. Since the energy absorption effect of the recess is improved, the moving distance of the occupant (stroke of the occupant) before the occupant stops is reduced. Therefore, the need for increasing the output of the inflator is eliminated and initial restraint of the occupant is safely achieved. The increased energy absorption effect also allows a reduction in the volume of the airbag so that a compactly constructed airbag may be used.

The angled surface of the airbag's recess, which extends from the deepest section of the recess to the right side end of the airbag (the right contact portion) and from the deepest section of the recess to the left side end of the airbag (the left contact portion), is adapted so that the area of the occupant's face opposite the center of gravity (mass point) of the occupant's head (i.e., the area between the eyebrows of the occupant) will always come into contact with the contact surface of the airbag. The angled surface extends such that the contact surfaces extending from the deepest section of the recess to the right and left side ends of the contact surface (the right and left contact portions) form an angle of about 15 to 90 degrees (preferably 30 to 60 degrees) relative to the line extending through the deepest section of the recess in the longitudinal direction of the vehicle (the airbag centerline). In such an airbag, the restraint force of the recess is focused on the area of the occupant's head corresponding to the mass point thereby absorbing the kinetic energy of the occupant's head in a most efficient manner. In addition, when the occupant has a small build, the seat is often pulled forward to the front-most position. When such an occupant is plunged into the airbag during a vehicle collision, the recess allows frontward movement of the occupant. Thus, the recess provides an extra distance (stroke) for the occupant's head to move frontward and allows the occupant to be sufficiently decelerated by a seat belt before the occupant's head makes contact with the airbag.

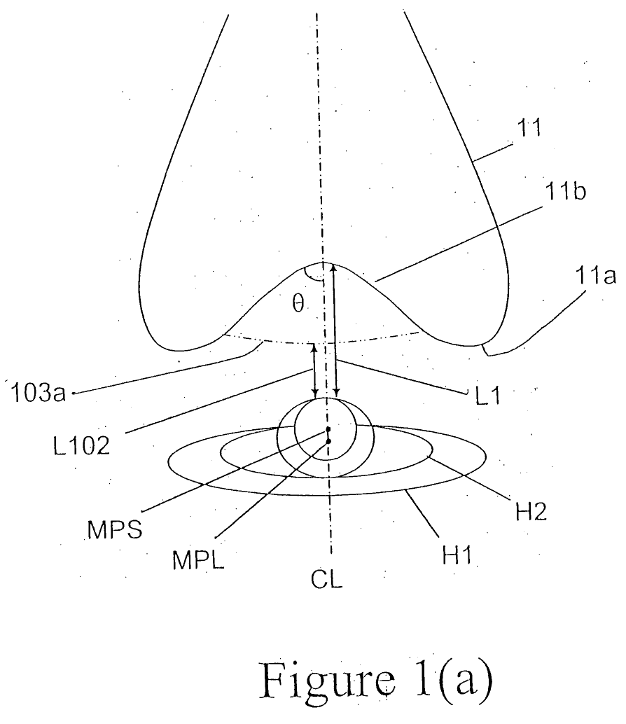

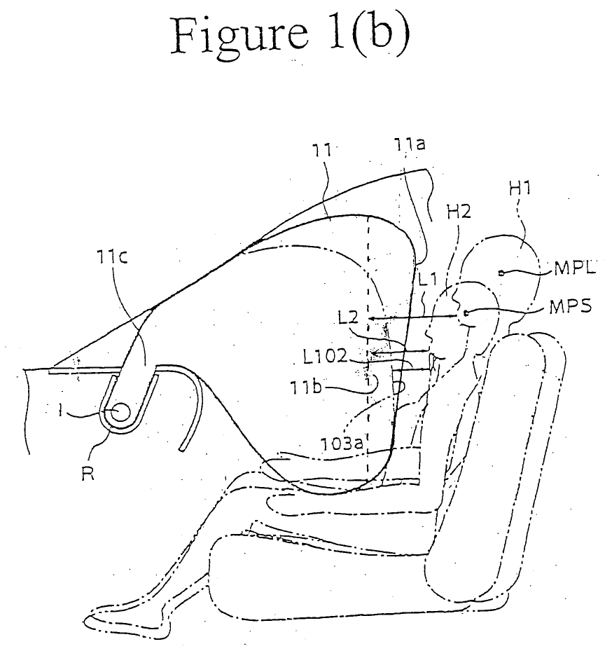

FIG. 1(a) is a schematic top view showing a front-passenger airbag device in the fully deployed state according to an embodiment of the present invention. FIG. 1(b) is a schematic side view of the airbag device in FIG. 1(a). The airbag device has a retainer R disposed facing the windshield above the instrument panel of a vehicle. Arranged in the retainer R are an airbag 11 preferably made of fabric and an inflator I for supplying gas into the airbag for deployment of the airbag. The airbag 11 is normally stored inside the retainer R in a folded state. The volume of the airbag 11 is in a range of approximately 110 to 132 liters when the airbag 11 is of a small size. The base of the airbag 11 has a narrow end opening (gas inlet) 11c, which is connected to the inflator I. The end opening 11c allows the flow of gas from the inflator I into the airbag 11. The front face of the airbag 11 has a contact surface 11a, which comes in contact with the occupant when the airbag deploys.

A recess 11b is provided in the vicinity of the center area of the contact surface 11a of the airbag 11. The recess 11b may be in the form of, for example, a constriction, a hollow, or a valley in the airbag. The recess 11b preferably extends from the top of the airbag 11 to the bottom of the airbag 11 so that the recess 11b is visible in a top view of the airbag. In the preferred embodiment, the fully deployed airbag 11 has a configuration in its top view showing a right side portion, a left side portion, and a recess formed between the left side portion and the right side portion.

FIGS. 1(a) and 1(b) show two occupants H1, H2 of different builds. The occupant H1 has a larger build than the occupant H2. The distance between the jaw area of the occupant H1 and the recess 11b (center of the contact surface 11a) of the deployed airbag is indicated by L1. The distance between the jaw area of the occupant H2 and the recess 11b (center of the contact surface 11a) of the deployed airbag is indicated by L2. For example, L1, L2 may be on the order of 100 mm or the like. For comparison, a contact surface 103a of a conventional airbag is also shown. As can be seen, the distance L102 between the contact surface 103a of a conventional airbag and the jaw area of the occupant H2 is less than the distance L2 between the jaw area of the occupant H2 and the center of the contact surface 11a.

Thus, in the airbag device shown in FIGS. 1(a) and 1(b), the existence of the recess 11b makes the distance L2 between the occupant H2 and the contact surface 11a not so different from the distance L 1 between the occupant H1 and the contact surface 11a. This enables the occupant H2 also to be sufficiently decelerated by the seat belt before the head portion of the occupant H2 comes into contact with the airbag 11.

In FIGS. 1(a) and 1(b), the mass points (position of center of gravity) of the heads of the occupants H1, H2 are represented by MPL and MPS, respectively. In the airbag device according to this embodiment, a front surface of the airbag is formed so that the portions of the heads of the occupants H1, H2 corresponding to the mass points MPL, MPS will come into contact with the front surface area of the airbag extending (or projecting) from the deepest section of the recess 11b to the right side end (the right contact portion) and from the deepest section of the recess 11b to the left side end (the left contact portion) toward the occupants H1, H2. Thus by projecting the front surface of the airbag in a direction toward the occupant, the occupant can be restrained more safely during the initial stage of the impact than is possible with a conventional airbag.

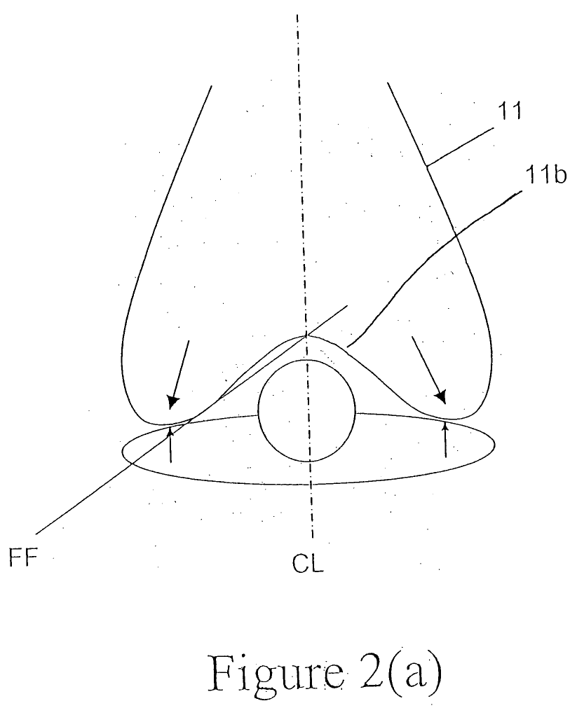

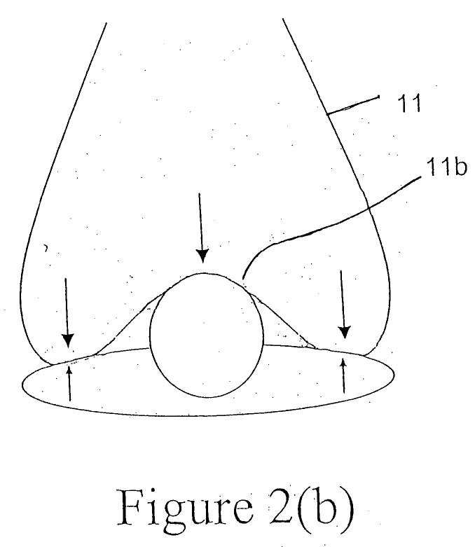

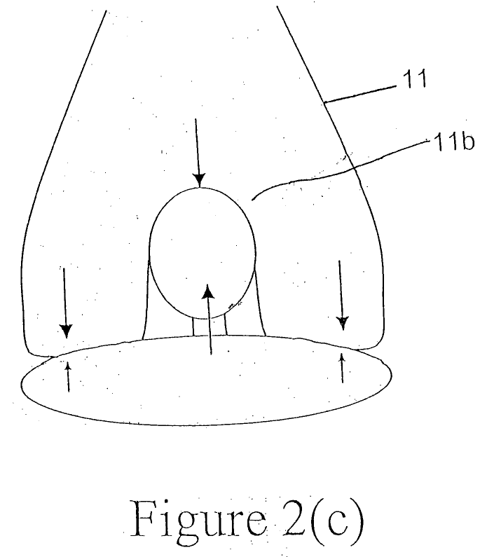

With reference to FIG. 2, additional configurations and functions of an airbag device according to an embodiment of the present invention will now be described. FIG. 2(a) is a schematic top view showing a state where the occupant is moving forward. FIG. 2(b) is a schematic top view showing a state where the occupant's face just comes into contact with the airbag. Finally, FIG. 2(c) is a schematic top view showing a state where the occupant is being restrained by the airbag.

As shown in FIG. 2(a), when an occupant has moved forward, the shoulder portions of the occupant first come into contact with the airbag 11. Inside the airbag 11, bold arrows indicate reactive force (pressure). In this embodiment, a recess 11b restricts the flow of pressure, thereby preventing pressure from escaping from the right and left portions (shoulder/side projections) of the airbag 11 to ensure that the occupant is fully restrained during the initial stage of the impact. Thus, it is necessary to form the airbag so that the recess maintains its recessed shape even when the pressure is applied to the right and left portions of the airbag.

FIG. 2(b) shows a moment when the occupant's face just comes into contact with the airbag. In FIG. 2(b), a line FF extends toward and an occupant from the deepest section of the recess 11b to left side end of the recess 11b (FFL) and from the deepest section of the recess 11b to the right side end of the recess 11b (FFR). The line FF (FFL, FFR) forms an angle of about 15 to 90 degrees (preferably 30 to 60 degrees) relative to the line CL extending through the deepest section of the recess in the longitudinal direction of the vehicle. In other words, the angle θ is formed at the intersection of the line FF (or the contact surface 11a) and the line CL. In this way, the area of the occupant's head corresponding to the center of gravity MP of the occupant's head (the area between the eyebrows) can be restrained with certainty, and the kinetic energy of the head can be absorbed in a most efficient way.

FIG. 2(c) shows a state where the occupant is fully restrained by the airbag 11. As the occupant further moves forward from the state in FIG. 2(b), the shoulder portions of the occupant push against the right and left side portions of the airbag, thereby compressing the right and left sides of the airbag. Since the shape of the recess 11b is maintained even when the inner pressure of the airbag rises, much of the gas pressure is kept from escaping. Consequently, the reaction force of the right and left sides of the airbag increases, enhancing the initial occupant restraint capability. Thus, gas pressure is effectively supplied to all portions of the airbag, including the recess 11b. As a result, the energy absorption effect of the recess is improved. The stroke of the occupant's head is reduced, the need for boosting the inflator output is eliminated, and the volume of the airbag can be made smaller. In addition, providing the recess 11b allows the occupant to be sufficiently decelerated by the seat belt before the occupant's head plunges into the airbag 11.

Additional embodiments of the airbag 11 according to the present invention will now be described. In the following embodiments and examples, various methods are employed so that the shape of the recess is maintained even when the right and left sides of the airbag are compressed as shown FIG. 2(a).

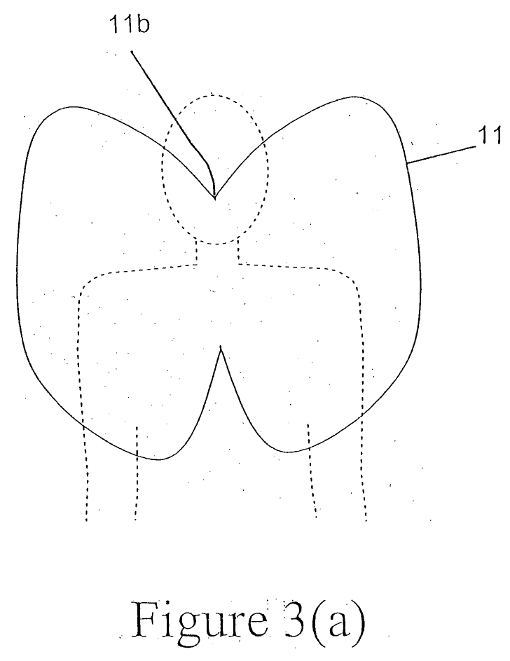

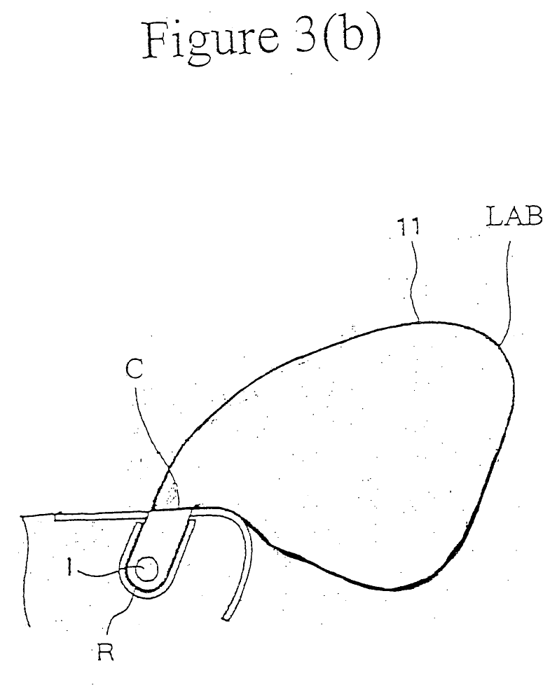

FIGS. 3(a) and 3(b) show another embodiment according to the present invention. FIG. 3(a) shows an airbag 11 when deployed. FIG. 3(b) shows a left half side airbag LAB. The airbag 11 of FIG. 3(a) is formed by connecting two airbags-a right side airbag and a left side airbag-together to form one airbag 11. As shown in FIG. 3(b), an opening I for inserting an inflator is provided at the base of the airbag. As in FIGS. 1(a) and 1(b), the front side of the airbag 11 comprises a contact surface 11a, which makes contact with an occupant when the airbag deploys. A recess 11b is provided in the center area of the contact surface.

As shown in FIG. 3(b), the left half side airbag LAB and the right half side airbag have a communication portion C, which communicates with one end of the left half side airbag LAB and one end of the right half side airbag. The communication portion C is disposed at the base side of the airbag 11. Therefore, the left half side airbag LAB and the right half side airbag inflate respectively in a direction away from the communication portion C.

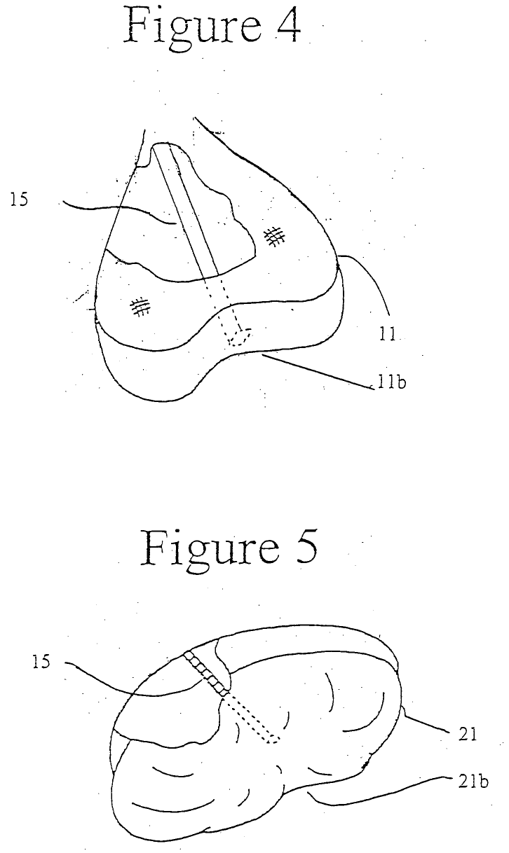

FIG. 4 shows another embodiment according to the present invention. In this embodiment, a tether belt is attached to the recess 11b of the airbag 11. The airbag 111 shown in FIG. 4 is similar to the airbag shown in FIG. 3(a). The tether belt 15 is sewn to the inner surface of the airbag 11 adjacent to the bottom of the recess 11b. The other end of the tether belt 15 is sewn to the inner surface of the airbag 11 adjacent to the end opening of the airbag 11. The tether belt 15 is made of a material with an expansion rate lower than that of the airbag 11. The tether belt 15 may, for example, be a string or a band-shaped cloth. By adding a tether belt 15, the shape of the recess 11b can be maintained when the airbag 11 is inflated.

FIG. 5 shows another embodiment according to the present invention. In this embodiment, a tether belt 15 is attached to a conventional airbag 21. FIG. 5 shows a conventional airbag 21 without a recess 11b. One end of the tether belt 15 is sewn to the inner surface of the airbag 21 adjacent to the central area of the airbag facing the occupant. The other end of the tether belt 15 is sewn to the airbag 21 adjacent to the end opening of the airbag. When the airbag 21 inflates, the central area of the airbag facing the occupant is pulled by the tether belt 15 to form a recess 21b. Since this embodiment can be applied to a conventional airbag, construction of the airbag can be made easy.

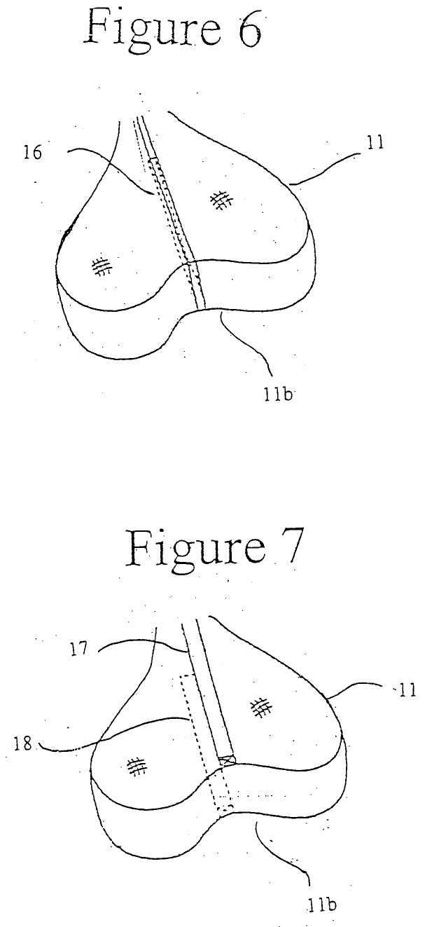

FIG. 6 shows another embodiment according to the present invention. In this embodiment, tether belts 16 are attached to the outside surface of the airbag surrounding the recess 11b of the airbag 11. The airbag 11 shown in FIG. 6 is similar to the airbag shown in FIG. 3(a). Tether belts 15 are wrapped around the recess 11b of the airbag. Ends of the tether belts are sewn to the airbag adjacent to the end opening of the airbag.

FIG. 7 shows another embodiment according to the present invention. In this embodiment, tether belts 17, 18 are attached to the airbag 11 on the upper and lower surface of the airbag adjacent to the recess 11b.

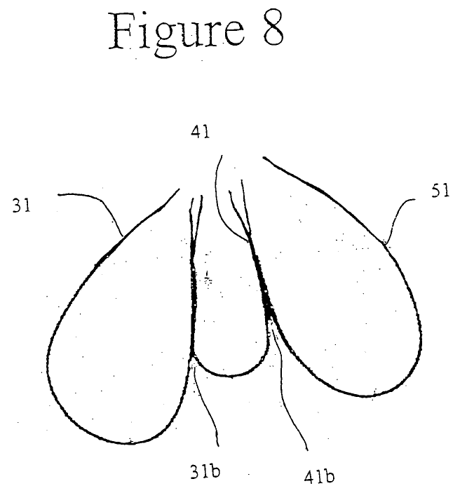

FIG. 8 shows another embodiment according to the present invention. In this embodiment, three airbags 31, 41, 51 are employed. An inflator (not shown) is provided for each of the airbags. As shown in FIG. 8, recesses 31b, 41b are formed on a front surface formed by the airbags 31, 41, 51.

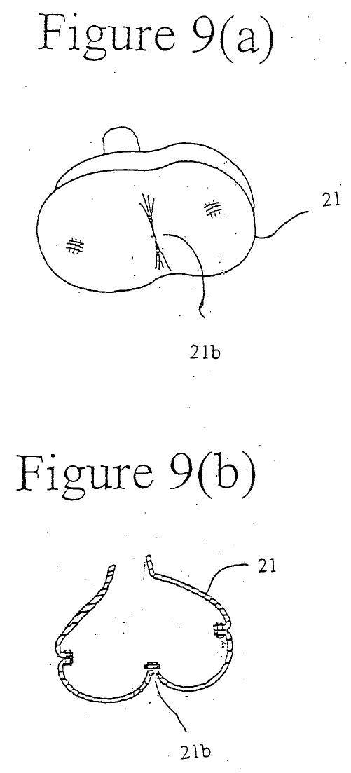

FIG. 9 shows another embodiment according to the present invention. FIG. 9(a) is a perspective view of this embodiment. FIG. 9(b) is a cross sectional view of the embodiment of FIG. 9(a). In this embodiment, a part of a conventional airbag 21 is sewn together and also the periphery of the conventional airbag is sewn together. The sewn parts form a recess 21b in the front of the airbag 21.

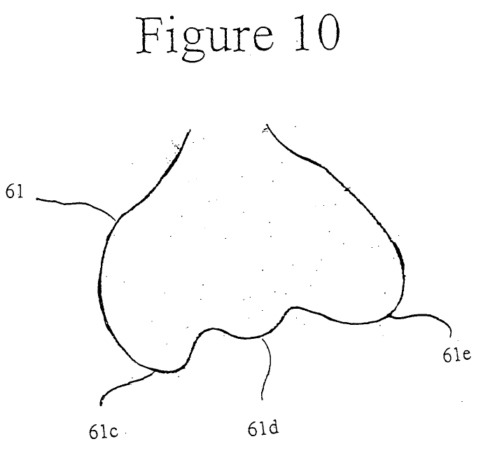

FIG. 10 shows another embodiment according to the present invention. In this embodiment, the airbag 61 has three projecting portions 61c, 61d, 61e. To construct this airbag, any of the methods used to produce the above embodiments can be used. Thus, the number of projecting portions of the airbag according to the invention can be increased to three.

The present invention in its broader aspects is not limited to the specific airbag devices according to the embodiments shown and described herein with reference to FIGS. 1 through 10.

As described above, by modifying the configuration of the airbag 11 according to the present invention, an occupant can be protected in a more efficient manner.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. An airbag device for protecting an occupant of a vehicle, comprising:
an airbag having a left portion, a right portion, and a recess disposed between the left portion and the right portion;
wherein the recess is configured to extend from a bottom of the airbag to a top of the airbag; and
wherein the recess is adapted to maintain a recess shape when the airbag is deployed and pressure is applied to the right portion, the left portion, or the right and left portions.

2. The airbag device of claim 1, wherein the recess comprises a constriction.

3. The airbag device of claim 1, wherein the recess comprises a hollow.

4. The airbag device of claim 1, wherein the recess comprises a valley.

5. The airbag device of claim 1, wherein the recess includes a contact surface adapted to contact the occupant when the airbag deploys.

6. The airbag device of claim 1, wherein the recess includes a center portion, a left surface, and a right surface, and wherein the center portion is disposed at a deepest point of the recess.

7. The airbag device of claim 6, wherein the left surface extends from the center portion in a direction toward an occupant and forms a first angle of approximately 15 to 90 degrees with a line extending through the center portion in a longitudinal direction of the vehicle, and wherein the right surface extends from the center portion in a direction toward an occupant and forms a second angle of approximately 15 to 90 degrees with a line extending through the center portion in a longitudinal direction of the vehicle.

8. The airbag device of claim 7, wherein the first and second angles are 30 to 60 degrees.

9. The airbag device of claim 6, wherein the left surface extends from the center portion toward a left side end of the airbag and the right surface extends from the center portion toward a right side end of the airbag.

10. The airbag device of claim 9, wherein the center portion, left surface, and right surface are configured to contact an area of a head of the occupant opposite a center of gravity of the head.

11. The airbag device of claim 1, wherein the airbag comprises two airbags connected together.

12. The airbag device of claim 1, wherein the airbag includes a tether having a first end connected to an inner surface of the airbag adjacent to a bottom of the recess and a second end connected to the inner surface of the airbag adjacent to an end opening of the airbag, and wherein the tether is configured to maintain a shape of the recess when the airbag is inflated.

13. The airbag device of claim 1, wherein the airbag includes a tether disposed around the recess, and wherein the tether is connected to an exterior portion of the airbag.

14. The airbag device of claim 1, wherein the airbag includes a first tether attached to an upper surface of the airbag adjacent to the recess and a second tether attached to a lower surface of the airbag adjacent to the recess.

15. The airbag device of claim 1, wherein the airbag comprises three airbags disposed side by side.

16. The airbag device of claim 1, wherein the airbag includes a sewn portion configured to form the recess when the airbag is inflated.

17. The airbag device of claim 1, wherein the airbag includes a second recess.

18. An airbag device for protecting an occupant of a vehicle, comprising:
an airbag having a left portion and a right portion;
wherein the left portion and the right portion form a contact surface adapted to contact the occupant when the airbag deploys;
and wherein an angle between the left portion and the right portion is 30 to 180 degrees in a plane parallel to a horizontal direction of the vehicle;
wherein the contact surface extends from a top portion of the airbag to a bottom portion of the airbag; and
wherein the left and right portions are adapted to maintain the angle when the airbag is deployed and pressure is applied to the left portion, the right portion, or the left and right portions.

19. An airbag device for protecting an occupant of a vehicle, comprising:
an airbag; and
a tether having a first end and a second end;
wherein the first end is connected to an inner surface of the airbag adjacent to a central portion of the airbag and the second end is connected to the inner surface of the airbag adjacent to an end opening of the airbag;
wherein the airbag is configured to form a recess at the central portion when the airbag is deployed; and
wherein the recess extends from a top portion of the airbag to a bottom portion of the airbag.
